(19) United States
(12) Patent Application Publication
(10) Pub. No.: US 2003/0163616 A1
(43) Pub. Date: Aug. 28, 2003

(54) Communication Device, Computer, and Communication Control Method

(75) Inventor: Takashi Yanagisawa, Yokohoma-shi (JP)

Correspondence Address: IBM CORPORATION, PO BOX 12195, DEPT 9CCA, BLDG 002, RESEARCH TRIANGLE PARK, NC, 27709, US

(73) Assignee: INTERNATIONAL BUSINESS MACHINES CORPORATION, Armonk, NY (US)

(21) Appl. No.: 10/248,862

(22) Filed: Feb. 25, 2003

(30) Foreign Application Priority Data
Feb. 25, 2002 (JP) 2002-048846

(51) Int. Cl. G06F 13/00

(52) U.S. Cl. 710/33

(57) ABSTRACT

A communication device, a computer, and a communication control method is provided that enables data to be more efficiently transmitted while reducing power consumption. An input device employing a communication device which transmits data comprises an input module that operates a key matrix and a microcomputer as an input part to which external data is input, a transmission module that operates the microcomputer and a transmission circuit having a transmission power level from which data is transmitted to an external unit, and a determination module and a transmission stop module which operate the microcomputer as a synchronous controller that determines on the input history of data from the input part whether or not to reduce the level of a synchronous signal transmitted by the transmission power level.

### BACKGROUND OF THE INVENTION

The present invention relates to a communication device, a computer, and a communication control method. In particular, the present invention relates to a communication device that improves the efficiency of data communication on the basis of an input history of data to be transmitted, as well as a computer and a communication control method using this communication device.

Communication between a plurality of communication devices can be roughly classified into methods of carrying out communication through connections of cables or the like and methods of carrying out wireless communication. The wireless communication is used if a user moves his or her communication device or carries it with him or her, if cable wiring affects the arrangement of the devices or creates an esthetic problem, or in other cases.

For example, a wireless keyboard wirelessly communicates with a PC (Personal Computer) main body or the like. This enables the keyboard and the PC main body or the like to communicate with each other without any cables. Accordingly, the arrangement of the PC is prevented from being obstructed by cables. Further, the PC remains esthetically preferable.

For communication devices, it is desirable to eliminate a connection of a power supply established using a power cable or the like, for the same reason as that for the elimination of cables between the communication devices. In particular, communication devices using wireless communication are generally provided with a power supply such as a battery in order to take advantage of the absence of communication cables.

For such communication devices operated using a battery, it is desirable to increase the battery life. The extension of battery life is particularly important for an input device such as a keyboard which tends to be operated for a long time.

It is thus a purpose of the present invention to provide a communication device, a computer, and a communication control device which can solve the above problems. This purpose is accomplished by a combination of characteristics set forth in the independent claims. Further, the dependent claims define other advantageous specific examples of the present invention.

### BRIEF SUMMARY OF THE INVENTION

That is, a first aspect of the present invention provides a communication device transmitting data, the communication device being characterized by comprising an input part to which external data is input, a transmission power level from which the data is transmitted to an external unit, and a synchronous controller which determines based on an input history of the data from the input part whether or not levels of synchronous signals transmitted by the transmission power level are lowered, as well as a computer using this communication device.

A second aspect of the present invention provides a communication device transmitting data, the communication device being characterized by comprising an input part to which external data is input, a transmission power level from which the data is transmitted to an external unit, a reception part which receives an instruction to reduce levels of synchronous signals transmitted by the transmission power level, from a device receiving the data transmitted by the transmission section, and a synchronous controller which determines based on the instruction received by the reception part whether or not levels of synchronous signals transmitted by the transmission power level are lowered, as well as a computer using this communication device.

A third aspect of the present invention provides a communication control method used for a communication device transmitting data, the method being characterized by comprising a first step of receiving externally input data, a second step of transmitting the data to an external unit, and a third step of determining on the basis of an input history of the data in the first step whether or not levels of the synchronous signals transmitted to the external unit are lowered.

The above summary of the present invention does not list all required features of the present invention. Subcombinations of this group of characteristics may constitute the present invention.

### BRIEF DESCRIPTION OF THE SEVERAL VIEWS OF THE DRAWINGS

Some of the purposes of the invention having been stated, others will appear as the description proceeds, when taken in connection with the accompanying drawings, in which:

FIG. 1 is a diagram showing a configuration of a personal computer 100 according to the present embodiment;

FIG. 2 is a diagram showing a configuration of an input device 120 and a wireless receiver 130 according to the present embodiment;

FIG. 3 is a time chart showing the relationship between inputs to and transmissions from the input device 120 according to the present embodiment;

FIG. 4 is a flow chart of control of a transmission from the input device 120 according to the present embodiment;

FIG. 5 is a diagram showing a transmission control method (prediction method A) based on input timings and used for the input device 120 according to the present embodiment;

FIG. 6 is a diagram showing a transmission control method (prediction method B) based on input timings and used for the input device 120 according to the present embodiment;

FIG. 7 is a table showing an example of an input timing history table 247 referenced by a determination module 244 according to the present embodiment in executing a prediction method C;

FIG. 8 is a table showing an example of an input content history table 248 referenced by the determination module 244 according to the present embodiment in executing a prediction method D;

FIG. 9 is a flow chart showing a prediction process executed by the input device 120 according to the present embodiment;

FIG. 10 is a time chart showing the relationship between inputs to and transmissions from the input device 120 according to a first variation of the present embodiment;

FIG. 11 is a diagram showing a configuration of the input device 120 and the wireless receiver 130 according to a second variation of the present embodiment; and

FIG. 12 is a diagram showing a hardware configuration of a personal computer main body 110 according to the present embodiment.

### DETAILED DESCRIPTION OF THE INVENTION

While the present invention will be described more fully hereinafter with reference to the accompanying drawings, in which a preferred embodiment of the present invention is shown, it is to be understood at the outset of the description which follows that persons of skill in the appropriate arts may modify the invention here described while still achieving the favorable results of this invention.

Accordingly, the description which follows is to be understood as being a broad, teaching disclosure directed to persons of skill in the appropriate arts, and not as limiting upon the present invention.

The present invention will be described below with reference to its embodiment. However, the embodiment described below does not limit the invention. Further, the solution according to the present invention does not require all combinations of characteristics described in the embodiment.

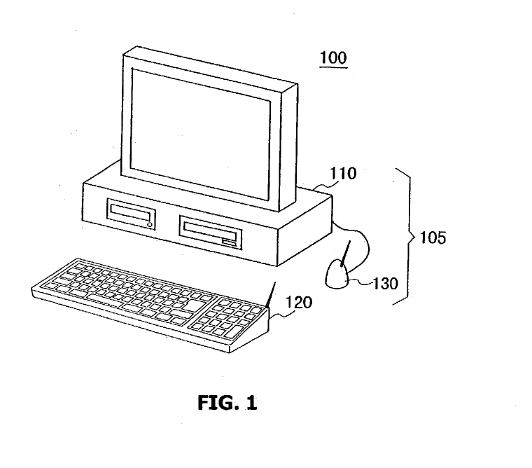

Referring now more particularly to the accompanying drawings, FIG. 1 shows a configuration of a personal computer 100 according to the present embodiment. The personal computer 100 according to the present embodiment comprises an information processing device 105 and an input device 120. The input device 120 is an example of a communication device according to the present invention.

The information processing device 105 executes programs according to a user's instructions to process information. The information processing device 105 has a personal computer main body 110 and a wireless receiver 130. The personal computer main body 110 executes programs on the basis of the user's inputs and displays the results of the execution or the like. The wireless receiver 130 receives data transmitted by the input device 120 through wireless communication. It then transfers the data to the personal computer main body 110 via a cable.

The input device 120 receives the user's input key operations and transmits the data corresponding to the input operation to the wireless receiver 130 through wireless communication. Wireless communication from the input device 120 to the radio receiver 130 may be communication based on radio electric waves such as a 27 MHz band, infrared communication, or the like. The input device 120 according to the present embodiment operates using an internally stored battery as a power source. In order to extend the battery life, the input device 120 reduces the time required to transmit radio waves to the wireless receiver 130 to save power for data transmissions.

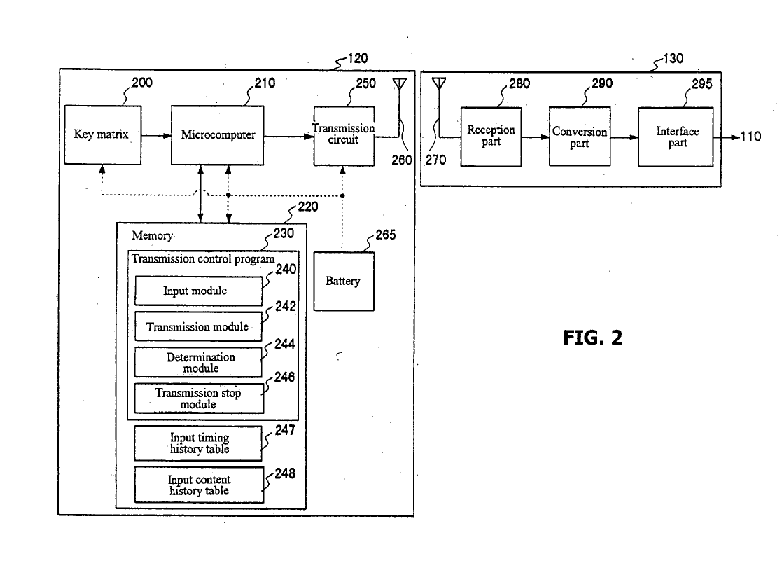

FIG. 2 shows a configuration of the input device 120 and the wireless communication device 130 according to the present embodiment. The input device 120 has a key matrix 200, a microcomputer 210, a memory 220, a transmission circuit 250, an antenna 260, and a battery 265.

The key matrix 200 receives the user's input key operations. The microcomputer 210 operates on the basis of programs stored in the memory 220. It transmits data corresponding to the key operation input to the key matrix 200, to the wireless receiver 130. When the user operates the keys, the microcomputer 210 may treat the user's depression of any key on the key matrix 200 and the release of the key that has been depressed by the user, as separate inputs. In this case, depending on whether the user has depressed any key on the key matrix 200 or released the key that has been depressed by the user, the microcomputer 210 may separately transmit, to the wireless receiver 130, a combination of a code corresponding to the depressed key and data indicating that the key has been depressed or a combination of a code corresponding to the released key and data indicating that the key has been released. Alternatively, when the user operates the keys, the microcomputer 210 may determine the execution of an input when the user depresses any key on the key matrix 200 and then releases it before transmitting a code corresponding to this key to the wireless receiver 130. The memory 220 stores programs executed by the microcomputer 210, data used by it, and the like. The transmission circuit 250 receives data to be transmitted to the wireless receiver 130 from the microcomputer 210. It then executes processes such as modulation, frequency conversion, and power amplification to generate transmitted signals. The transmission circuit 250 then transmits data indicating the content of a key operation or the like to the information processing device 105 via the antenna 260. The antenna 260 wirelessly transmits the transmitted signals generated by the transmission circuit 250 to the wireless receiver 130 in the information processing device 105. The battery 265 supplies power to the parts of the input device 120, i.e. the key matrix 200, the microcomputer 210, the memory 220, the transmission circuit 250, and others.

The memory 220 retains a transmission control program 230 providing control required to transmit data corresponding to key operations to the wireless receiver 130, an input timing history table 247 that stores the history of input timings of the user's key operations, and an input content history table 248 that stores the history of input contents of the user's key operations.

The transmission control program 230 includes an input module 240, a transmission module 242, a determination module 244, and a transmission stop module 246.

The input module 240, resident in memory 220, operates the microcomputer 210 to process the key matrix 200 to which external data is input. When executed, the input module 240 controls the microcomputer 210 to scan the key matrix 200 to receive the input key operation performed on the key matrix 200 by the user. Then, the microcomputer 210 generates key data corresponding to the input key operation.

The transmission module 242, resident in memory 210, operates the microcomputer 210 and the transmission circuit 250 to transmit data at a transmission power level. Prior to executing the transmission module 242, the microcomputer 210 generates data to be transmitted to the wireless receiver 130 and then transmits the data to the transmission circuit 250 under control of the microcomputer 210n executing the transmission module 242. The transmission module 242 according to the present embodiment generates the two types communication data shown below, as data to be transmitted to the wireless receiver 130.

(1) Communication Data Corresponding to Key Data

When the user inputs a key operation to the key matrix 200, the microcomputer 210 executes the transmission module 242 to transmit the key data to the transmission circuit 250 as communication data.

(2) Communication Data Corresponding to Synchronous Signal

The input device 120 establishes synchronism with the radio receiver 130 before transmitting the key data to the radio receiver 130. Thus, if the transmission circuit 250 is not carrying out any transmissions to the wireless receiver 130, the microcomputer 210 executes the transmission module 242 to transmit communication data corresponding to a synchronous signal to the wireless receiver 130 before transmitting the key data. The synchronous signal enables a reception part 280 of the wireless receiver 130 to obtain the frequency of communication data transmitted by the transmission circuit 250. Specifically, the synchronous signal is used to match, for example, a PLL (Phase Locked Loop) in the reception part 280 with the frequency of the communication data transmitted by the transmission circuit 250.

The input device 120 and wireless receiver 130 according to the present embodiment use, for example, communication data with a particular data pattern as a synchronous signal.

The microcomputer 210 when executing the determination module 244 and the transmission stop module 246, both resident in memory 220, operate the transmission circuit 250 as a synchronous controller. To execute the determination module 244, the microcomputer 210 determines on the input history of key data from the input module 240 whether or not a condition is present indicating that the input module 240 will not receive any subsequent inputs for a predetermined duration. Specifically, the microcomputer 210 uses a prediction method already incorporated in the determination module 244 to calculate the duration expected to elapse before the input module 240 receives the subsequent input (predicted duration). In calculating the predicted duration, the microcomputer 210 references the input timing history table 247 and/or the input content history table 248. Then, if the predicted duration is longer than a predetermined value, the microcomputer 210 determines that the condition is present indicating that the input module 240 will not receive any subsequent inputs for the predetermined duration. The determination module 244 according to the present embodiment uses the duration required to synchronize between the transmission circuit 250 and the reception part 280 as the predetermined duration.

To execute the transmission stop module 246, the microcomputer 210 controls the transmission of the synchronous signals to the wireless receiver 130 executed by the transmission module 242 and the transmission circuit 250. Specifically, after the transmission circuit 250 has transmitted key data to the wireless receiver 130, the transmission stop module 246 determines on the basis of the result of the determination by the determination module 244 whether the transmission is to be stopped or the synchronous signal is to be consecutively transmitted.

When the transmission from the transmission module 242 and the transmission circuit 250 is stopped, the synchronism between the wireless receiver 130 and the transmission circuit 250 is cleared. In this case, the transmission module 242 and the transmission circuit 250 must transmits the synchronous signal to the wireless receiver 130 again before transmitting the next key data in order to synchronize the wireless receiver 130 to the frequency of the communication data. To execute the transmission stop module 246, the microcomputer 210 stops the transmission circuit 250 from transmitting the synchronous signal if the determination module 244 determines the condition is present indicating that the input module 240 will not receive any subsequent inputs for the predetermined duration. In this manner, the transmission stop module 246 stops the transmission of the synchronous signal if it is determined that no key data will be transmitted for the predetermined duration. This prevents the transmission circuit 250 from consuming power in order to continue transmitting the synchronous signal.

In the above processing, the transmission stop module 246 may reduce the level of the synchronous signal transmitted by the transmission circuit 250 instead of completely stopping the transmission of the synchronous signal if it is determined that there will not be any subsequent inputs for the predetermined duration.

On the other hand, when the input device 120 consecutively transmits the synchronous signal after the key data, the wireless receiver 130 can maintain the synchronism with the transmission circuit 250. Accordingly, the transmission module 242 and the transmission circuit 250 can transmit the subsequent key data to the wireless receiver 130 without newly establishing synchronism. Thus, to execute the transmission stop module 246, the microcomputer 210 continues transmitting the synchronous signal if the determination module 244 determines that there will be the subsequent input. Thus, the transmission stop module 246 prevents the transmission circuit 250 from consuming power by transmitting the synchronous signal in order to synchronize the wireless receiver 130 again.

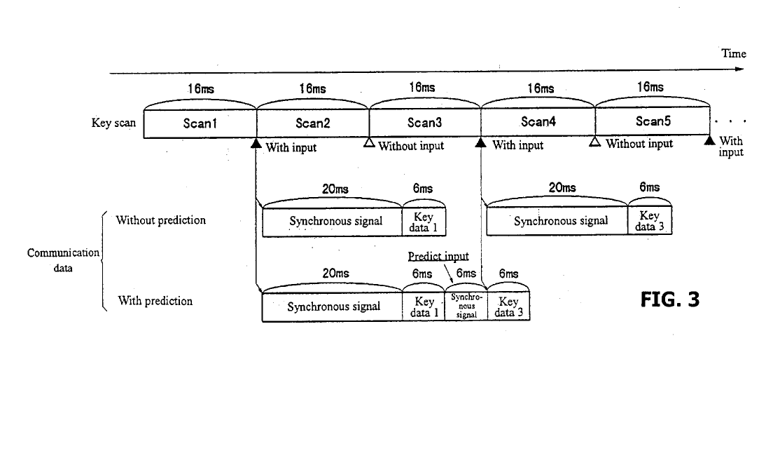

The wireless receiver 130 has an antenna 270, the reception part 280, a conversion part 290, and an interface part 295. The antenna 270 wirelessly receives transmitted signals transmitted by the transmission circuit 250 using the antenna 260. The reception part 280 recovers communication data by executing processes such as amplification and demodulation on the transmitted signals transmitted from the transmission circuit 250 and received by the antenna 270. If the communication data is the synchronous signal, the reception part 280 uses the received synchronous signal to synchronize with the transmission circuit 250 in the input device 120. If the communication data is the key data, the reception part 280 transmits the received key data to the conversion part 290. The conversion part 290 converts the key data into, for example, a data format corresponding to a keyboard input interface in the personal computer main body 110. The interface part 295 transmits the key data converted by the conversion part 290 to the personal computer main body 110 via a cable. FIG. 3 shows a time chart showing the relationship between inputs to and transmissions from input device 120 according to the present embodiment. The horizontal axis in FIG. 3 indicates the elapse of time. The vertical direction in FIG. 3 indicates a key scan timing and the timing with which the transmission circuit 250 transmits communication data.

The “key scan” in FIG. 3 indicates the timing with which the input module 240 scans the key matrix 200. The input module 240 according to the present embodiment, for example, scans the key matrix 200 every 16 ms (milliseconds) for input key operations. FIG. 3 shows, by way of example, the case in which key data corresponding to a key operation is input during a scan 1, a scan 3, and a scan 5. Here, the key data input during the scans 1, 3, and 5 may correspond to the depression of keys or the release of them.

The communication data (no predictions) indicates transmission timings used if the transmission stop module 246 stops the transmission of the synchronous signal whenever the key data has been transmitted. The transmission circuit 250 according to the present embodiment must transmit as an example the synchronous signal for 20 ms in order to synchronize with the reception part 280. Further, the transmission circuit 250 according to the present embodiment requires, by way of example, 6 ms to transmit the key data.

If the synchronous signal is stopped whenever the key data has been transmitted, the transmission circuit 250 must synchronize with the reception part 280 by transmitting the synchronous signal for 20 ms before each of transmission of key data 1 corresponding to the scan 1 and transmission of key data 3 corresponding to the scan 3 as shown in FIG. 3.

The communication data (with predictions) indicates transmission timings used if the transmission stop module 246 correctly determines whether or not there will be the subsequent input. In this case, the determination module 244 determines on the basis of input history of the scans 1 and 2, and the like that there will be the subsequent input during the scan 3 (the point of time 6 ms after the transmission of the key data 1). As a result, the determination module 244 determines that there will be subsequent input within the duration (=20 ms) required to synchronize with the wireless receiver 130. Upon receiving the result of the determination from the determination module 244, the transmission stop module 246 allows the transmission module 242 and the transmission circuit 250 to consecutively transmit the synchronous signal after transmitting the key data 1. Thus, the transmission module 242 and the transmission circuit 250 can transmit the key data 3 input during the scan 3 without newly establishing synchronism with the wireless receiver 130.

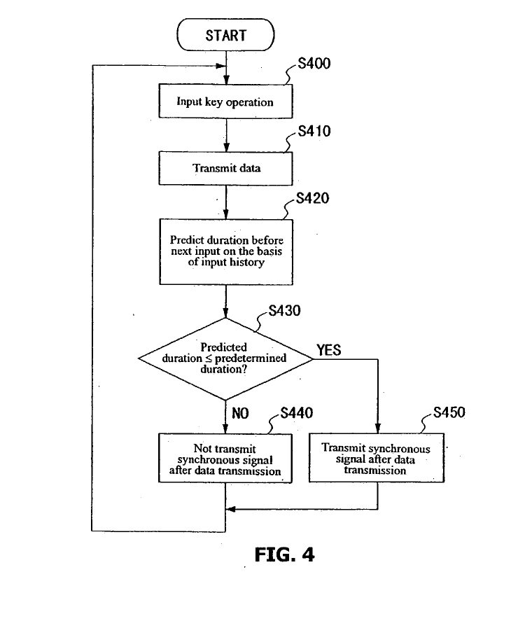

FIG. 4 shows the flow of control of transmissions from the input device 120 according to the present embodiment. First, the microcomputer 210 and the input module 240 scan the key matrix 200 to receive the user's key operation input to the key matrix 200 (S400). Then, the microcomputer 210, the transmission module 242, and the transmission circuit 250 transmit the key data corresponding to the key operation input during step S400, to the wireless receiver 130 (S410). In this case, if synchronism with the wireless receiver 130 has not been established when the key operation is input, the microcomputer 210, the transmission module 242, and the transmission circuit 250 transmit the synchronous signal for 20 ms before transmitting the key data. Then, the microcomputer 210 and the determination module 244 calculate the duration (predicted duration) expected to elapse before the next input, on the basis of the input history of the key data (S420). Then, the microcomputer 210 and the transmission stop module 246 compare the predicted duration calculated in step S420 with the duration (20 ms) required to synchronize (S430). If it is determined that “predicted duration >predetermined duration” in step S430, the microcomputer 210 and the transmission stop module 246 stop the transmission circuit 250 from transmitting the synchronous signal (S440). On the other hand, if it is determined that “predicted duration Â£ predetermined duration” in step S430, the microcomputer 210 and the transmission stop module 246 allow the transmission circuit 250 to consecutively transmit the synchronous signal (S450).

If there are no subsequent inputs during step S450, the microcomputer 210 and transmission stop module 246 may stop the transmission of the synchronous signal, for example, when an error is detected.

The determination module 244 according to the present invention is provided with the methods shown below to calculate the predicted duration in step S420.

(1) Prediction Method A

On the basis of the input history of the key data input by the input module 240, the microcomputer 210 and the determination module 244 compare a difference in time required to transmit radio waves between the case in which the synchronous signal is transmitted after the key data and the case in which it is not transmitted after the key data. Then, if the microcomputer 210 and the determination module 244 determine that the radio wave transmission time can be more reduced if the synchronous signal is transmitted after the key data than if it is not transmitted after the key data, they determine that the synchronous signal be consecutively transmitted after the key data.

(2) Prediction Method B

The microcomputer 210 and the determination module 244 calculate the input period of the key data input by the input module 240. Then, the microcomputer 210 and the determination module 244 determine on the basis of the input period whether or not to allow the synchronous signal to be consecutively transmitted.

(3) Prediction Method C

The microcomputer 210 and the determination module 244 retrieve, from the input timing history table 247, a timing partly matching the timing with which the key data has been input by the input module 240. Then, the microcomputer 210 and the determination module 244 determine on the basis of the result of the retrieval whether or not to allow the synchronous signal to be consecutively transmitted.

(4) Prediction Method D

The microcomputer 210 and the determination module 244 retrieve, from the input content history table 248, an input content partly matching the content of the key data input by the input module 240. Then, the microcomputer 210 and the determination module 244 determine on the basis of the result of the retrieval whether or not to allow the synchronous signal to be consecutively transmitted.

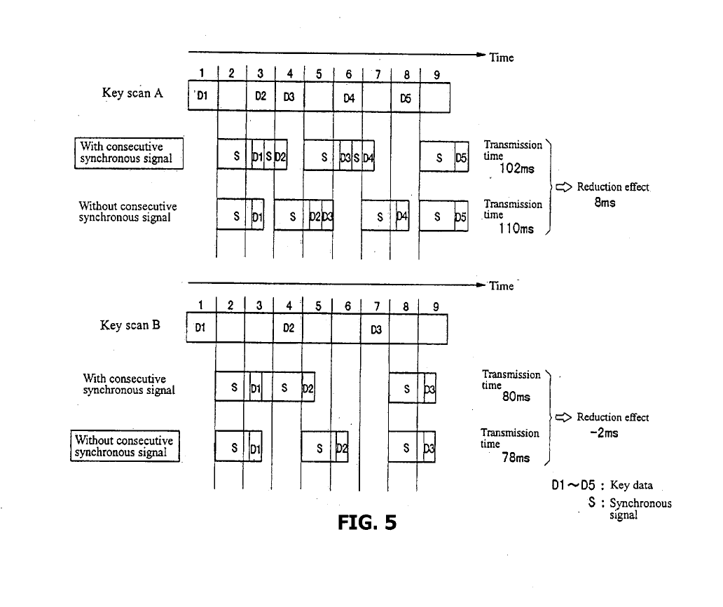

Each of the prediction methods A to D will be described below with reference to FIGS. 5 to 8.

FIG. 5 shows a transmission control method (prediction method A) based on input timings for the input device 120 according to the present embodiment. To execute the prediction method A, the microcomputer 210 and the determination module 244 compare, for the last nine key scans, a difference in time required to transmit radio waves between the case in which the synchronous signal is transmitted after the key data and the case in which it is not transmitted after the key data. Then, if the microcomputer 210 and the determination module 244 determine that the radio wave transmission time can be more drastically reduced if the synchronous signal is transmitted after the key data than if it is not transmitted after the key data, they determine that the synchronous signal be consecutively transmitted after the key data. In this case, after synchronism has been established, the input device 120 according to the present embodiment operates after transmitting the first key data, to determine whether or not to consecutively transmit the synchronous signal.

For example, if the key scan A in FIG. 5 has been input and if the synchronous signal is consecutively transmitted after the transmission of the first key data following the establishment of synchronism, then the input device 120 can transmit the pair of key data D1 and D2, the pair of key data D3 and D4, and the key data D5 by establishing synchronism once. On the other hand, if the synchronous signal is not consecutively transmitted after the transmission of the first key data following the establishment of synchronism, then the input device 120 can transmit only one key data except for the pair of key data D2 and D3 by establishing synchronism once.

On the basis of the transmission patterns in the above two cases, the microcomputer 210 and the determination module 244 calculate the radio wave transmission time to be 102 ms in the case in which the synchronous signal is consecutively transmitted. The microcomputer 210 and the determination module 244 also calculate the radio wave transmission time to be 110 ms in the case in which the synchronous signal is not consecutively transmitted. Then, the microcomputer 210 and the determination module 244 determine that the synchronous signal be consecutively transmitted after the key data because the reduction in radio wave transmission time amounts to 8 ms if the synchronous signal is consecutively transmitted.

On the other hand, if the key scan B in FIG. 5 has been input and if the synchronous signal is consecutively transmitted after the transmission of the first key data following the establishment of synchronism, then the input device 120 can transmit the key data D1 and D2 by establishing synchronism once. However, the input device 120 must transmit the synchronous signal for 22 ms between the key data D1 and D2. On the other hand, if the synchronous signal is not consecutively transmitted after the transmission of the first key data following the establishment of synchronism, the input device 120 must synchronize every time one key data is transmitted.

On the basis of the transmission patterns in the above two cases, the microcomputer 210 and the determination module 244 calculate the radio wave transmission time to be 80 ms in the case in which the synchronous signal is consecutively transmitted. The microcomputer 210 and the determination module 244 also calculate the radio wave transmission time to be 78 ms in the case in which the synchronous signal is not consecutively transmitted. Then, the microcomputer 210 and the determination module 244 determine that the synchronous signal not be consecutively transmitted after the key data because the reduction in radio wave transmission time amounts to −2 ms if the synchronous signal is consecutively transmitted.

As shown above, the input device 120 determines whether the synchronous signal be consecutively transmitted on the basis of the reduction in radio wave transmission time accomplished if the synchronous signal is consecutively transmitted for the last specified duration after the transmission of the key data. This enables it to be determined whether or not to continue transmitting the synchronous signal, on the basis of the tendency of the timing with which the key data is input by the input module 240. This serves to reduce the time required to transmit the synchronous signal.

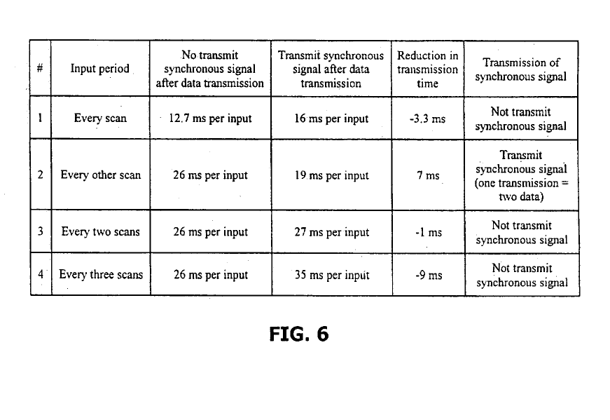

FIG. 6 shows a table showing a transmission control method (prediction method B) based on the input period of the input device 120 according to the present embodiment. FIG. 6 shows the following items for the case in which the user inputs a key operation during every scan or at the intervals of one scan, two scans, or three scans: the time required to transmit data per input if the synchronous signal is transmitted after data and if it is not transmitted after the key data, a reduction in time required to transmit data if the synchronous signal is transmitted after the data, and whether or not the synchronous signal is transmitted after the key data.

To execute the prediction method B, the microcomputer 210 and the determination module 244 determines on the basis of the input period, an example of the timing with which data is input to the input module 240, whether or not the condition is present indicating that there will not be any subsequent inputs to the input module 240 for the predetermined duration. A description will be given below of whether or not the input device 120 transmits the synchronous signal after the transmission of the key data, for each input period in FIG. 6.

(1) If the User Inputs a Key Operation During Each Scan (Every 16 ms)

If the synchronous signal is not to be transmitted after the data, the input device 120 repeats a pattern in which the transmission of the synchronous signal (20 ms), key data 1 (6 ms), key data 2 (6 ms), and key data 3 (6 ms) and the stoppage of the transmission (10 ms) are sequentially executed. Accordingly, the transmission time per input is (20 ms+6 ms×3)/3=12.7 ms.

On the other hand, if the synchronous signal is transmitted after the transmission of the data, the input device 120 repeats a pattern in which the key data (6 ms) and the synchronous signal (10 ms) are sequentially transmitted stably. Consequently, the transmission time per input is 16 ms.

(2) If the User Inputs a Key Operation Every Other Scan (Every 32 ms)

If the synchronous signal is not transmitted after the data, the input device 120 repeats a pattern in which the transmission of the synchronous signal (20 ms) and key data (6 ms) and the stoppage of the transmission (6 ms) are sequentially executed. Consequently, the transmission time per input is 26 ms.

On the other hand, if the synchronous signal is transmitted after the transmission of the data, the input device 120 repeats a pattern in which the transmission of the synchronous signal (20 ms), key data 1 (6 ms), synchronous signal (6 ms), and key data 2 (6 ms), and the stoppage of the transmission (26 ms) are sequentially executed stably. Consequently, the transmission time per input is 19 ms.

(3) If the User Inputs a Key Operation Every Two Scans (Every 48 ms)

An operation similar to that in (2) is performed if the synchronous signal is not transmitted after the transmission of the data.

On the other hand, if the synchronous signal is transmitted after the transmission of the data, the input device 120 repeats a pattern in which the synchronous signal (20 ms), the key data 1 (6 ms), the synchronous signal (22 ms), the key data 2 (6 ms), and the stoppage of the transmission (26 ms) are sequentially transmitted stably. Consequently, the transmission time per input is 27 ms.

(4) If the User Inputs a Key Operation Every Three Scans (Every 64 ms)

An operation similar to that in (2) is performed if the synchronous signal is not transmitted after the transmission of the data.

On the other hand, if the synchronous signal is transmitted after the transmission of the data, the input device 120 repeats a pattern in which the transmission of the synchronous signal (20 ms), key data 1 (6 ms), synchronous signal (38 ms), key data 2 (6 ms), and the stoppage of the transmission (58 ms) are sequentially executed stably. Consequently, the transmission time per input is 35 ms.

As shown above, if the user inputs a key operation during every other scan, the input device 120 can reduce the transmission time per input by transmitting the synchronous signal after the transmission of the first key data. Accordingly, the microcomputer 210 and the transmission stop module 246 consecutively transmits the synchronous signal after the transmission of the first key data if the user inputs a key operation every other scan.

In the above process, the determination module 244 may determine the period of the user's key inputs on the basis of, for example, the number of inputs during a past particular duration.

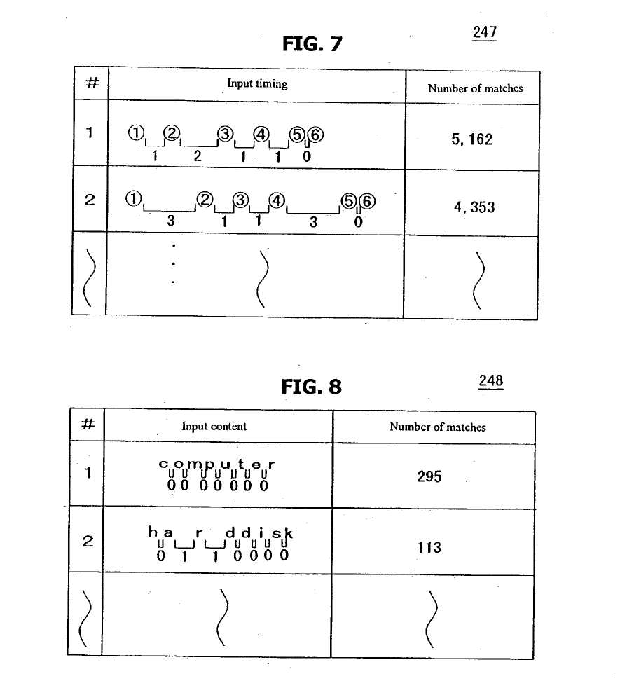

FIG. 7 shows an example of the input timing history table 247, referenced by the determination module 244 according to the present embodiment in executing the prediction method C. The input timing history table 247 includes an input timing field and a number-of-matches field. The input timing field contains the user's key input timings. The number-of-matches field contains the number of times that a key operation has been input with the same timing that is stored in the input timing field.

For example, the first line in FIG. 7 corresponds to a history indicating that the interval between the first and second key inputs is equal to one scan (16 ms), the interval between the second and third key inputs is equal to two scans, . . . , the fifth and sixth key inputs are consecutive (the interval corresponds to zero scan), and that an input based on such timings has been executed 5,162 times so far.

To allow the determination module 244 to execute the prediction method C, the microcomputer 210 can determine whether or not the condition is present indicating that the input module 240 will not receive any subsequent inputs for the predetermined duration, on the basis of the timings with which the data is input to the input module 240. That is, to allow the determination module 244 to execute the process, the microcomputer 210 retrieves, from each row of the previously input input timing history table 247, a timing partly matching the timing with which the data has been input to the input module 240. Then, if any partly matching input timing is present in the input timing history table 247, then on the basis of the input timing stored in the input timing field of the corresponding row, the microcomputer 210 determines, as a predicted duration, the duration elapsing after the particular part with the matched timing has been input and before the data next to the particular part is input. Then, the microcomputer 210 allows the transmission stop module 246 to stop the synchronous signal transmitted by the transmission circuit 250 on condition that the predicted duration exceeds a predetermined value.

Further, to allow the determination module 244 to execute the prediction method C, the microcomputer 210 increments the number of matches in the rows with input timings matching the plurality of key operations being input. In this case, if there are no rows with input timings matching the plurality of key operations being input, the microcomputer 210 may register the plurality of key operations being input, in the input timing history table 247. In this case, for example, the microcomputer 210 may delete the row with the minimum number of matches to obtain a sufficient storage area for the input timing history table 247.

FIG. 8 shows an example of the input content history table 248 referenced by the determination module 244 according to the present embodiment to execute the prediction method D. The input content history table 248 includes an input content field and a number-of-matches field. The input content field contains the contents of the user's key inputs. In the description of FIG. 8, for convenience, it is assumed that the microcomputer 210 determines that an input has been executed when the user depresses any key on the key matrix 200 and then releases it. In this regard, the same description applies to the case in which the user's depression of any key on the key matrix 200 and the release of the key that has been depressed by the user are treated as separate inputs except that a key code and data indicating that the key has been depressed or released are stored in the input content field. The number-of-times field contains the number of times that a key operation has been input with the same timing that is stored in the input content field.

For example, the second row in FIG. 8 corresponds to a history indicating that the key inputs for “h” and “a” are consecutive (the interval corresponds to zero scan), the interval between the key inputs for “a” and “r” corresponds to one scan, . . . , and the key inputs for “s” and “k” are consecutive and that an input based on such timings has been executed 113 times so far.

To allow the determination module 244 to execute the prediction method D, the microcomputer 210 can determine on the basis of the data input by the input module 240, whether or not the condition is present indicating that the input module 240 will not receive any subsequent inputs for the predetermined duration. That is, to allow the determination module 244 to execute the process, the microcomputer 210 retrieves, from each row of the previously input content history table 248, an input content partly matching the content of the data input to the input module 240. Then, if any partly matching input content is present in the input content history table 248, then on the basis of the input timing stored in the input content field of the corresponding row, the microcomputer 210 determines, as a predicted duration, the duration elapsing after the particular part with the matched content has been input and before the data next to the particular part is input. Then, the microcomputer 210 allows the transmission stop module 246 to stop the synchronous signal transmitted by the transmission circuit 250 on condition that the predicted duration exceeds a predetermined value.

Further, to allow the determination module 244 to execute the prediction method D, the microcomputer 210 increments the number of matches in the rows with data matching the plurality of data being input by key operations. In this case, if there are no rows with data matching the plurality of data being input by key operations, the microcomputer 210 may register the plurality of data being input by key operations, in the input content history table 248. In this case, for example, the microcomputer 210 may delete the row with the minimum number of matches to obtain a sufficient storage area for the input content history table 248.

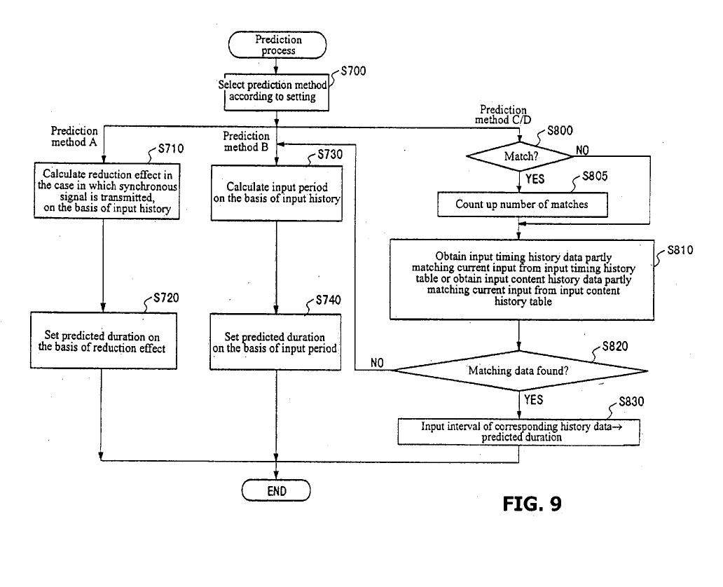

FIG. 9 shows the flow of a prediction process (executed in step S420 in FIG. 4) executed by the input device 120 according to the present embodiment. First, the determination module 244 selects a process corresponding to the prediction method already set in the input device 120 by the user or the like (S700). Then, the determination module 244 proceeds to step S710, S730, or S800 if it selects the prediction method A, B, or C or D, respectively.

If the prediction method A is selected in step S700, the determination module 244 calculates a difference in time required to transmit radio waves, between the case in which the synchronous signal is transmitted after the transmission of the key data and the case in which it is not transmitted after the transmission of the key data. The determination module 244 thus determines a reduction effect (S710). Then, if a reduction effect is produced, the determination module 244 sets the predicted duration to such a value that the synchronous signal can be consecutively transmitted after the transmission of the key data (S720). In step S720, the determination module 244 may directly output the result of the determination in step S430 in FIG. 4, on the basis of the reduction effect, rather than setting the predicted duration.

If the prediction method B is selected in step S700, the determination module 244 calculates the period of the user's key inputs on the basis of the input history of the key data from the input module 240 (S730). The determination module 244 sets the predicted duration on the basis of the calculated input period (S740).

If the prediction method C or D is selected in step S700, the determination module 244 checks whether or not any row in the input timing history table 247 or input content history table 248 matches the input timings or contents of the plurality of key operations being input (S800). If any matching row is found in step S800, the determination module 244 counts up the number of matches according to the number of matching rows found (S805).

Then, the determination module 244 obtains history data on the input timing partly matching the current input, from the input timing history table 247. Alternatively, the determination module 244 obtains history data on the input content partly matching the current input, from the input content history table 248 (S810). Then, if there is any history data on the partly matching input timing or content (S820), the determination module 244 sets the predicted duration on the basis of the input interval stored in the history data (S830). On the other hand, if there are no history data on the partly matching input timing or content (S820), the determination module 244 proceeds to step S730 to set the predicted duration on the basis of the input period (S730 and S740).

Instead of executing the above illustrated prediction process, the determination module 244 may set the predicted duration on the base of any one of the prediction method A (S720), prediction method B (S740), prediction method C (S810), and prediction method D (S810) or combination thereof.

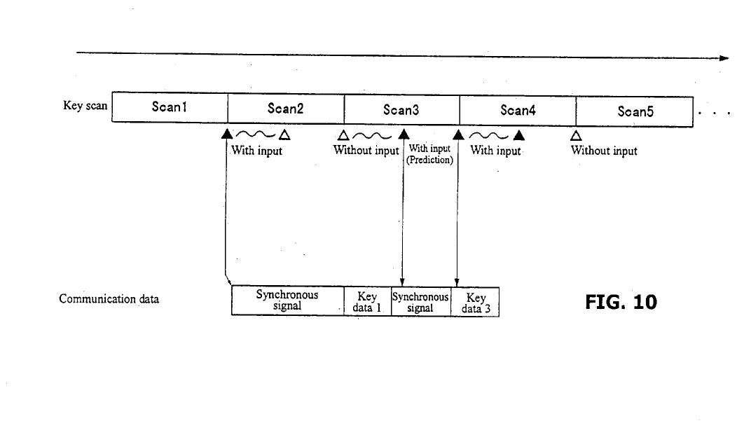

FIG. 10 is a time chart showing the relationship between inputs to and transmissions from the input device 120 according to a first variation of the present embodiment.

In the key matrix 200 or the like, which provides contact inputs, a chattering phenomenon may occur wherein when a contact is switched on or off, an input value fluctuates between the on and off values for a while before being stabilized. To avoid this phenomenon, a program for obtaining input data often determines key data on the basis of, for example, results of sampling of the key matrix 200 using a specified period.

The input device 120 according to the present variation prematurely reads a key operation input to the key matrix 200 by the user, before the corresponding key data is determined. The determination module 244 then makes a determination on the basis of the prematurely read data. That is, the determination module 244 prematurely reads the data input to the key matrix 200, from the input module 240, during a key scan before the key data is determined. The determination module 244 then determines on the basis of the prematurely read data whether or not the key matrix 200 will receive any subsequent input within the predetermined duration.

For example, during the scan 3 in FIG. 10, the determination module 244 prematurely determines during the key scan that the key matrix 200 is being operated. Then, if the prematurely read data indicates that an operation is being performed on the key matrix 200, the determination module 244 determines that a key operation is being input during the scan 3. In response to the determination by the determination module 244, the transmission stop module 246 consecutively transmits the synchronous signal after the key data 1. As a result, the transmission module 242 and the transmission circuit 250 can maintain synchronism with the wireless receiver 130 before the key data 3 is determined. This reduces the transmission time compared to the new establishment of synchronism.

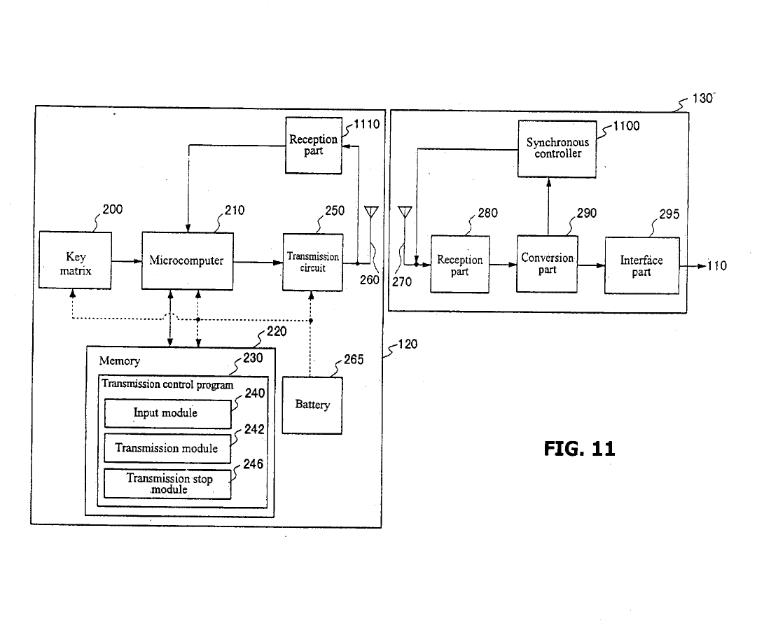

FIG. 11 shows a configuration of the input device 120 and the wireless receiver 130 according to a second variation of the present embodiment. The key matrix 200, microcomputer 210, transmission circuit 250, antenna 260, battery 265, antenna 270, reception part 280, conversion part 290, and interface part 295 are substantially similar to the corresponding members in FIG. 2. Their description is thus omitted.

A synchronous controller 1100 obtains key data transmitted by the input device 120, from conversion part 290. It then determines on the basis of the input history of the key data whether or not the condition is present indicating that the input module 240 will not receive any subsequent inputs for the predetermined duration. Specifically, in FIG. 2, the synchronous controller 1100 executes a process similar to that executed by the microcomputer 210, on the basis of the determination module 244. Then, if the synchronous controller 1100 determines that the condition is present indicating that the input module 240 will not receive any subsequent inputs for the predetermined duration, then it transmits an instruction to stop the synchronous signal transmitted by the transmission circuit 250 in the input device 120, to the input device 120 via the antenna 270. In this case, the synchronous controller 1100 may have the input timing history table 247 and/or input content history table 248.

A reception part 1110 receives the instruction to stop the synchronous signal transmitted by the transmission circuit 250 in the input device 120 via the antenna 260.

The memory 220 retains the transmission control program 230 that provides such control that data corresponding to key operations is transmitted to the wireless receiver 130. The transmission control program 230 includes the input module 240, the transmission module 242, and the transmission stop module 246. The input module 240 and the transmission module 242 are similar to the input module 240 and transmission module 242 shown in FIG. 2. Their description is thus omitted.

The transmission stop module 246 operates the microcomputer 210 as a synchronous controller for the input device 120. To execute the transmission stop module 246, the microcomputer 210 obtains the instruction to stop the synchronous signal from the reception part 1110 and then stops the transmission circuit 250 from transmitting the synchronous signal. In this case, upon receiving the instruction to stop the synchronous signal, the transmission stop module 246 may reduce the level of the synchronous signal transmitted by the transmission circuit 250 rather than completely stopping the transmission circuit 250 from transmitting the synchronous signal.

In the second variation shown above, the wireless receiver 130, in place of the input device 120, can execute the determination module 244 otherwise executed by the input device 120 as shown in FIG. 2. Thus, the input device 120 according to the present variation is prevented from consuming power to execute the determination module 244. This serves to reduce power consumption compared to the input device 120 shown in FIG. 2. Further, the wireless receiver 130 according to the present variation may consume more power than the input device 120. Alternatively, a central processing unit in a faster microcomputer or personal computer main body 110 can be used to execute processes corresponding to the determination module 244.

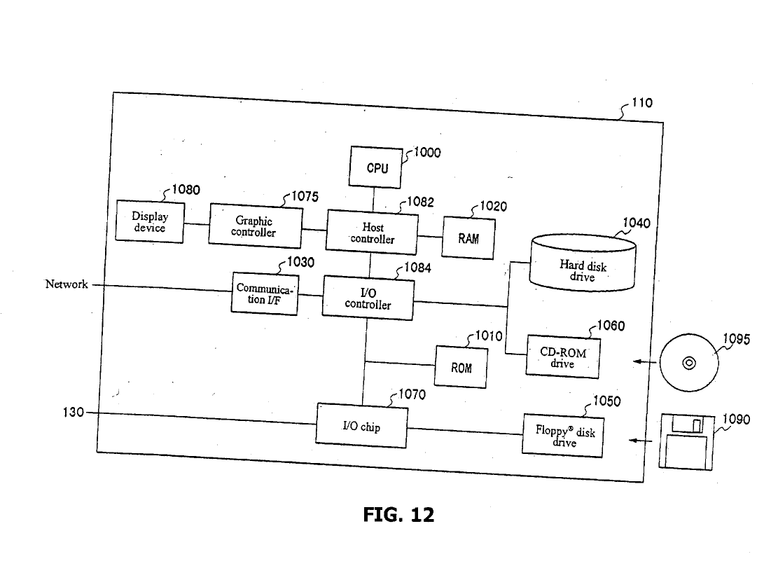

FIG. 12 shows an example of a hardware configuration of the personal computer main body 110 according to the present embodiment. The personal computer main body 110 according to the present embodiment comprises a CPU peripheral part having a CPU 1000 interconnected with a host controller 1082, a RAM 1020, a graphic controller 1075, and a display device 1080, and an I/O part having a communication interface 1030 connected to the host controller 1082 via an I/O controller 1084, a hard disk drive 1040, and a CD-ROM drive 1060, and a legacy I/O part having a ROM 1010 connected to the I/O controller 1084, a floppy disk drive 1050, and an I/O chip 1070.

The host controller 1082 connects together the RAM 1020 and the CPU 1000 and graphic controller 1075, which access the RAM 1020 at a high transfer rate. The CPU 1000 operates on the basis of programs stored in the ROM 11010 and the RAM 1020, to control each part. The graphic controller 1075 obtains image data generated by the CPU 1000 or the like on a frame buffer provided in the RAM 1020. The graphic controller 1075 thus displays the image data on the display device 1080. Alternatively, the graphic controller 1075 may contain a frame buffer storing image data generated by the CPU 1000 or the like.

The I/O controller 1084 connects together the host controller 1082, the communication interface 1030, a relatively fast I/O device, the hard disk drive 1040, and the CR-ROM drive 1060. The communication interface 1030 communicates with other devices via a network. The hard disk drive 1040 stores programs and data used by the personal computer main body 110. The CD-ROM drive 1060 reads a program or data from the CD-ROM 1095 to provide it to the I/O chip 1070 via the RAM 1020.

Further, the I/O controller 1084 connects to the ROM 1010 and to the floppy disk drive 1050, the I/O chip 1070, and other relatively slow I/O devices. The ROM 1010 stores a boot program executed by the CPU 1000 to activate the personal computer main body 110, programs dependent on the hardware of the personal computer main body 110, and others. The floppy disk drive 1050 reads a program or data from a floppy disk 1090 to provide it to the I/O chip 1070 via the RAM 1020. The I/O chip 1070 connects to the floppy disk 1090 and to various I/O devices via, for example, a parallel port, a serial port, a keyboard port, a mouse port, or the like (not shown). Further, the I/O chip 1070 receives data corresponding to the user's input from the input device 120 via the wireless receiver 130. It then provides this data to programs executed on the personal computer main body 110. Furthermore, the I/O chip 1070 transmits a program or data provided by the floppy disk drive 1050 or the CD-ROM drive 1060, to the input device 120 via the wireless receiver 130.

The transmission control program 230 is provided to the input device 120 by the user by storing it in a recording medium such as the floppy disk 1090, the CD-ROM 1095, or the IC-card (not shown). The transmission control program 230 is read from the recording medium and installed in the input device 120 via the I/O chip 1070. This program is then executed in the I/O device 120. Alternatively, the I/O device 120 further comprises a floppy disk drive, a CD-ROM drive, an IC card reader, or the like to read the transmission control program 230 directly from the recording medium.

The programs or modules shown above may be stored in an external storage medium. The storage medium may be the floppy disk 1090, the CD-ROM 1095, an optical recording medium such as a DVD, CD-RW, or a PD, a photomagnetic recording medium such as an MD, a tape medium, or a semiconductor memory such as an IC card. Further, a hard disk, a RAM, or the like provided in a server system connected to an exclusive communication network or the Internet may be used as a recording medium. Then, programs may be provided to the input device 120 via the network.

As shown above, the input device 120 according to the present embodiment can determine whether or not the key matrix 200 will receive any subsequent inputs. Then, on the basis of the determination, the input device 120 can further determine whether or not to transmit the synchronous signal to the personal computer main body 110. Thus, the input device 120 can reduce the time required to transmit data to the personal computer main body 110. This enables data to be more efficiently transmitted, while reducing power consumption.

Further, the input device 120 can determine on the basis of the periods, timings, and/or contents of inputs to the key matrix 200 whether or not the key matrix 200 will receive any subsequent inputs. Thus, the input device 120 can make more precise determinations. This enables data to be more efficiently transmitted, while reducing power consumption.

Although the present invention has been described in connection with its embodiment, the scope of the present invention is not limited to the range described in the above embodiment. Various changes or improvements may be made to the above embodiment. It is also evident from the claims that embodiments subjected to such changes or improvements are included in the scope of the present invention.

For example, the input device 120 may be a pointing device such as a mouse or a touch panel in place of a keyboard. In this case, the input device 120 is provided with means for obtaining input coordinates or the like in place of the key matrix 200. Alternatively, the input device 120 may be a communication device that transmits externally input data to the wireless receiver 130. In this case, the input device 120 is provided with means for receiving externally input data in place of the key matrix 200.

Further, the communication between the input device 120 and the wireless receiver 130 may be accomplished via cables or the like. Also in this case, the input device 120 according to the present embodiment can reduce the time required to transmit data to the personal computer main body 110. This enables data to be more efficiently transmitted, while reducing power consumption.

As is apparent from the above described invention, the present invention provides a communication device that enables data to be more efficiently transmitted while reducing power consumption, as well as a computer and a communication control method using this communication device.

In the drawings and specifications there has been set forth a preferred embodiment of the invention and, although specific terms are used, the description thus given uses terminology in a generic and descriptive sense only and not for purposes of limitation.

What is claimed is:

1. Apparatus comprising:
an input part which accepts data;
a transmitter which is operatively coupled to said input part and which transmits the data to an external device; and
a synchronous controller which is operatively coupled to said transmitter and to said input part and which determines the extent to which synchronization signals transmitted by said transmitter are curtailed based upon an input history of the data.

2. Apparatus of claim 1, wherein the external device is an information processing device and wherein said input part accepts data representative of a user's operation and wherein said transmitter transmits data indicating the content of the operation to the information processing device.

3. Apparatus of claim 2, wherein said input part is selected from the group consisting of a keyboard, touch screen and a mouse.

4. Apparatus of claim 1, wherein said synchronous controller uses the timing of the data accepted by said input part as the input history.

5. Apparatus of claim 4, wherein said synchronous controller curtails the synchronization signals in response to said synchronous controller determining that the timing of a currently accepted input data coincides with an input timing of a particular part of a previously accepted input data and only if a time duration between the input of the particular part and an input of a second particular part of a subsequently accepted input data exceeds a predetermined duration.

6. Apparatus of claim 5, wherein said input part is selected from the group consisting of a keyboard, touch screen and a mouse.

7. Apparatus of claim 1, wherein said synchronous controller uses the content of the data accepted by said input part as the input history.

8. Apparatus of claim 7, wherein said synchronous controller curtails the synchronization signals in response to said synchronous controller determining that the content of a currently accepted input data coincides with a particular part of a previously accepted input data and only if a time duration between the input of the particular part and an input of a second particular part of a subsequently accepted input data exceeds a predetermined duration.

9. Apparatus of claim 8, wherein said input part is selected from the group consisting of a keyboard, touch screen and a mouse.

10. Apparatus of claim 1, wherein the extent to which synchronization signals transmitted by said transmitter are curtailed is such that transmission of the synchronization signals is halted.

11. Apparatus of claim 1, wherein said transmitter uses electromagnetic waves to transmit the data.

12. Apparatus comprising:
an input part which accepts data;
a transmitter which is operatively coupled to said input part and which transmits the data to an external device;
a receiver which is operatively coupled to said transmitter and which receives a synchronization signal instruction from the external device; and
a synchronous controller which is operatively coupled to said transmitter and to said receiver and which determines the extent to which synchronization signals transmitted by said transmitter are curtailed based upon the synchronization signal instruction.

13. Apparatus of claim 12, wherein the external device is an information processing device and wherein said input part accepts data representative of a user's operation and wherein said transmitter transmits data indicating the content of the operation to the information processing device.

14. Apparatus of claim 13, wherein said input part is selected from the group consisting of a keyboard, touch screen and a mouse.

15. Apparatus of claim 12, wherein said transmitter uses electromagnetic waves to transmit the data.

16. A computing system comprising:
an information processing device; and
an input device which wirelessly transmits data to said information processing device, said input device having
an input part to which a user's operation is input and which generates operation data corresponding to the operation, a transmitter which transmits the operation data to said information processing device, and
a synchronous controller which determines the extent to which synchronization signals transmitted by the transmitter are curtailed based upon an input history of the operation data; wherein said information processing device includes a receiver which receives the operation data from the transmitter and establishes synchronism with the transmitter in response to receiving the synchronization signals.

17. The system of claim 16, wherein said input part is selected from the group consisting of a keyboard, touch screen and a mouse.

18. The system of claim 16, wherein the transmitter uses electromagnetic waves to transmit the data to the receiver.

19. A computing system comprising:
an information processing device; and
an input device which is wirelessly coupled to said information processing device, said input device having
an input part to which a user's operation is input and which generates operation data corresponding to the operation,
a transmitter which transmits the operation data to said information processing device,
a first receiver which receives a synchronization signal instruction from said information processing device, and
a first synchronous controller which determines the extent to which synchronization signals transmitted by the transmitter are curtailed based upon the synchronization signal instruction;
wherein said information processing device includes
a second receiver which wirelessly receives the operation data from the transmitter and establishes synchronism with the transmitter in response to receiving the synchronization signals; and
a second synchronous controller which determines the extent to which synchronization signals transmitted by the transmitter are curtailed based upon an input history of the operation data and which transmits the synchronization signal instruction to the first receiver specifying the extent to which the synchronization signals are reduced.

20. The system of claim 19, wherein the transmitter uses electromagnetic waves to transmit the data to the second receiver.

21. The system of claim 19, wherein said input part is selected from the group consisting of a keyboard, touch screen and a mouse.

22. A communication control method comprising the steps of:
accepting externally input data;
transmitting the data to an external device, wherein said transmitting step benefits from the transmission of synchronization signals along with the data; and
determining the extent to which the synchronization signals transmitted to the external unit are to be curtailed on the basis of an input history of the data accepted in said accepting step.

23. The communication control method of claim 22 further comprising the step of curtailing the transmission of the synchronization signals to the extent determined in said determining step.
